(19) United States
(12) Patent Application Publication
(10) Pub. No.: US 2013/0161867 A1
(43) Pub. Date: Jun. 27, 2013

(54) Molding Apparatus and a Method for Molding

(71) Applicants: Edward Fuergut, Dasing (DE); Juergen Hoegerl, Regensburg (DE)

(72) Inventors: Edward Fuergut, Dasing (DE); Juergen Hoegerl, Regensburg (DE)

(73) Assignee: Infineon Technologies AG, Neubiberg (DE)

(21) Appl. No.: 13/332,737

(22) Filed: Dec. 21, 2011

(51) Int. Cl. B29C 45/14

(52) U.S. Cl. 264/275; 425/557; 425/121

(57) ABSTRACT

An embodiment molding apparatus includes a main cavity and a buffer cavity connected with the main cavity.

### TECHNICAL FIELD

The present invention is related to a molding apparatus and a method for molding.

### BACKGROUND

In the technical field of molding processes and molding apparatuses an increasing demand exists for fabricating products with precisely defined shapes or dimensions. This applies in principle for all areas in which products as such are formed by mold materials or are embedded or encapsulated by mold materials. As one example, in the field of electronic devices semiconductor chips or dies are mostly encapsulated in a mold material in such a way that contact pads on a main surface of the semiconductor chips are connected with external contact elements on a main surface of the encapsulating material. One example is the so-called molded array package (MAP) which includes encapsulating any sort of carrier or interposer on one side, the carrier or interposer being made of, for example, a leadframe, a laminate, a Capton tape or a ceramic material. Another example is the so-called Embedded Wafer Level Ball Grid Array (eWLB) technology which was developed in particular to provide a wafer level packaging solution for semiconductor devices requiring a higher integration level and a greater number of external contacts. In particular, with respect to semiconductor chip package devices it becomes increasingly important to fabricate a semiconductor chip package device with a very small overall thickness which can be adjusted by the fabrication process in a precise manner within a small tolerance range. Such a demand for very thin semiconductor packages with a precisely defined thickness especially applies for chip card applications, but also for mobile communication chips and power chips.

### BRIEF DESCRIPTION OF THE DRAWINGS

The accompanying drawings are included to provide a further understanding of the disclosure and are incorporated in and constitute a part of this specification. The drawings illustrate embodiments and together with the description serve to explain principles of the disclosure. Other variations and many of the intended advantages of embodiments will be readily appreciated as they become better understood by reference to the following detailed description. The elements of the drawings are not necessarily to scale relative to each other. Like reference numerals designate corresponding similar parts.

FIG. 1 illustrates a schematic cross-sectional side view representation of a molding apparatus according to a first aspect;

FIG. 2 illustrates a schematic cross-sectional side view representation of a molding apparatus according to a second aspect;

FIG. 3 illustrates an exemplary schematic cross-sectional side view representation of a molding apparatus according to the disclosure;

FIG. 4 illustrates an exemplary schematic top view representation of a molding apparatus and a semiconductor chip carrier according to the disclosure;

FIG. 5 illustrates an exemplary schematic top view representation of a molding apparatus and a semiconductor chip carrier according to the disclosure; and

FIG. 6 illustrates a flow diagram for an exemplary method for molding according to a third aspect.

### DETAILED DESCRIPTION OF ILLUSTRATIVE EMBODIMENTS

In the following detailed description, reference is made to the accompanying drawings, which form a part hereof, and in which is shown by way of illustration specific embodiments in which the invention may be practiced. In this regard, directional terminology, such as “top,” “bottom,” “front,” “back,” “leading,” “trailing,” etc., is used with reference to the orientation of the figures being described. Because components of embodiments can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

The aspects and embodiments are now described with reference to the drawings, wherein like reference numerals are generally utilized to refer to like elements throughout. In the following description, for purposes of explanation, numerous specific details are set forth in order to provide a thorough understanding of one or more aspects of the disclosure. It may be evident, however, to one skilled in the art that one or more aspects of the embodiments may be practiced with a lesser degree of the specific details. In other instances, known structures and elements are shown in schematic form in order to facilitate describing one or more aspects of the disclosure. It is to be understood that other embodiments may be utilized and structural or logical changes may be made without departing from the scope of the disclosure. It should be noted further that the drawings are not to scale or not necessarily to scale.

In addition, features or aspects disclosed may be combined with one or more other features or aspects of the other implementations as may be desired and advantageous for any given or particular application. Furthermore, to the extent that the terms “include,” “have,” “with” or other variants thereof are used in either the detailed description or the claims, such terms are intended to be inclusive in a manner similar to the term “comprise.” The terms “coupled” and “connected,” along with derivatives may be used. It should be understood that these terms may be used to indicate that two elements co-operate or interact with each other regardless of whether they are in direct physical or electrical contact, or not in direct contact with each other. The following detailed description, therefore, is not to be taken in a limiting sense, and the scope of the present invention is defined by the appended claims.

In the following disclosure a molding apparatus or a method for molding are described both of which can be used for fabricating any sort of product or to encapsulate any sort of pre-fabricated product like, for example, a semiconductor chip. For that purpose a mold material or encapsulant material will be utilized. The encapsulant material can be, for example, any electrically insulating material like, for example, any kind of plastic mold material, any kind of epoxy material, or any kind of resin material with or without any kind of filler materials. The encapsulant material can also be any sort of electrically or thermally conducting material, sinter material, laminate material, nano-paste material, i.e., any material containing microscopic or nanoscopic particles, in particular conducting particles, or any material containing glass fibers or carbon fibers for use in, for example, the car industry. The encapsulant material can also be a ceramic paste, i.e., a material containing any sort of ceramic polymer or filler or ceramic particles, or hybrid epoxy/ceramic material.

In particular, when fabricating the semiconductor chips and the packaging of the semiconductor dies with the encapsulant material, fan-out embedded dies can be fabricated. The semiconductor chips can be arranged on substrates of any sort of shape or material like, for example, on square-shaped or circle-shaped substrates, on leadframe-based substrates, ceramic-based substrates, interposer substrates, laminate substrates, and flexible substrates. The fan-out embedded dies can be arranged in an array having the form, e.g., of a wafer and is therefore often called a “re-configured wafer.” However, it should be appreciated that the fan-out embedded die array is not limited to the form and shape of a wafer but can have any size and shape and any suitable array of semiconductor chips embedded therein. This technology is called extended wafer level packaging technology. It can also be defined that within this application the term “wafer” applies not only to circular shaped substrates but also to square-shaped substrates or substrates of any other shape. In the following the semiconductor chips packaged with the encapsulant material will be designated with the general term “semiconductor chip panel.”

In the claims and in the following description different examples of a method of fabricating a semiconductor device are described as a particular sequence of processes or measures, in particular in the flow diagrams. It is to be noted that the disclosure should not be necessarily limited to the particular sequence described. Particular ones or all of the different processes or measures can also be conducted simultaneously or in any other useful and appropriate sequence.

Aspects and embodiments of a molding apparatus and a method for molding can be used for fabricating products or fabricating an encapsulation layer for embedding products as, for example, a plurality of semiconductor chips. To this end, the individual semiconductor chips are placed on a carrier and a mold material can, for example, be dispensed onto a central portion of the array of semiconductor chips. Thereafter the carrier can then be placed in a molding apparatus and within the molding apparatus the dispensed mold material can be molded and cured to obtain a semiconductor chip encapsulated layer panel. The semiconductor chip panel can then be taken out of the molding apparatus for further processing and finally singulating the panel into a plurality of semiconductor chip package devices.

Referring to FIG. 1, there is shown a schematic cross-sectional side view representation of a molding apparatus according to a first aspect. The molding apparatus of FIG. 1 comprises a main cavity 1 and a buffer cavity 2 connected with the main cavity 1. In a method for molding described later, the main cavity 1 is intended to receive a carrier plate like, for example, a carrier plate containing a plurality of semiconductor chips, wherein the semiconductor chips are to be covered or encapsulated by an encapsulation material or mold material within the main cavity 1. For that purpose a mold material is dispensed into the main cavity 1, in particular on a central portion of the carrier plate and thereafter the spatial volume of the main cavity is reduced in such a way that the height of the main cavity 1 provides for a certain pre-defined height of the packaged semiconductor devices. Any excess mold material is driven out of the main cavity 1 into the buffer cavity 2. In this way a plurality of semiconductor device packages with a precisely defined height are produced. The purpose of the buffer cavity is to guarantee and to control an end pressure in the buffer cavity which is a key parameter in the molding process.

Molding apparatus 10 may comprise an end position which defines the main cavity 1 and the buffer cavity 2 and in which end position the entire cavity comprising the main cavity 1 and the buffer cavity 2 is dense to the outside so that no mold material can flow out and only excess mold material can flow from the main cavity 1 to the buffer cavity 2. In the schematic drawing of FIG. 1 this is indicated by the left vertical boundary line of the buffer cavity 2 and the right vertical boundary line of the main cavity 1. In a practical example of a molding apparatus these boundaries can be realized by a clamp ring which can be part of a first tool which moves downwards until it reaches the upper surface of a second tool and thereby defines the end position in which the main cavity 1 and the buffer cavity 2 are closed to the outside. In this end position the main cavity 1 has a precisely defined clear height which defines the height of semiconductor packages formed by the molding process. An end position as described before, can also be called a tool-defined end position.

The end position as described before is not necessarily defined by a mechanical stop such as a mechanical stop of a clamp ring of an upper tool reaching an upper surface of a lower tool. The end position can also be defined by an exact motor control of a first tool moving downwards a second tool by software control of the motor or motors driving the first tool. For example, it can be controlled that the downward movement of the first upper tool comes to a stop when the distance between the first and second tool is exactly 150 μm, for example, so clear height of the main cavity is precisely defined in this way. Of course also in this case it must be guaranteed that in the end position the entire cavity, i.e., main cavity and buffer cavity, is dense to the outside. An end position as described before can also be called a machine-defined or software-defined or software-controlled end position.

Buffer cavity 2 may comprise a variable spatial volume. Buffer cavity 2 is shown to have a number of boundary walls. One of these boundary walls can, for example, be configured as a movable or displaceable boundary wall so that the volume of the buffer cavity 2 can be varied. In the schematic drawing of FIG. 1 this movable boundary wall can be given as the upper horizontal boundary line of the buffer cavity 2. In addition the movable boundary wall can be preloaded by a force like a spring force acting on the movable boundary wall in a direction so as to reduce the spatial volume of the buffer cavity. As a practical example, the movable boundary wall can be realized by a plunger which can move up and down within the buffer cavity 2 thereby changing its spatial volume. A spring force acting on the plunger in a downward direction counteracts against the expansion of excess mold material flowing into the buffer cavity 2 from the main cavity 1. In this way a certain pre-defined end pressure of the molding process can be adjusted.

A passage 3 can be formed between the main cavity 1 and the buffer cavity 2 for excess mold material to flow from the main cavity 1 to the buffer cavity 2. The passage 3 can be situated such that it comprises a boundary wall, which is in one and the same plane as that of a boundary wall of the main cavity 1, and another opposing boundary wall, which is that of a wall separating the main cavity 1 from the buffer cavity 2. The distance between these opposing boundary walls of the passage 3 can, for example, be less than 1000 μm, or less than 500 μm, or even less than 100 μm, in particular 10 μm to 50 μm, more particular 20 μm to 40 μm.

It is also possible that two or more buffer cavities are connected with the main cavity. The buffer cavities can either have identical construction, form and spatial volume or alternatively can also have different construction, form or spatial volume for any reason.

Main cavity 1 can have a square shape or a circular shape in a top view, in particular for housing therein a carrier panel having also square shape or circular shape like, for example, a re-configured circular or square shaped “wafer” comprising a plurality of semiconductor devices for embedded wafer level packaging. According to an embodiment thereof, the molding apparatus 10 can then have two or more buffer cavities 2 connected at lateral positions to the main cavity 1. The buffer cavities can then be arranged at pre-defined lateral positions of the main cavity, in particular at regularly spaced angular positions. A specific embodiment thereof will be shown and described later.

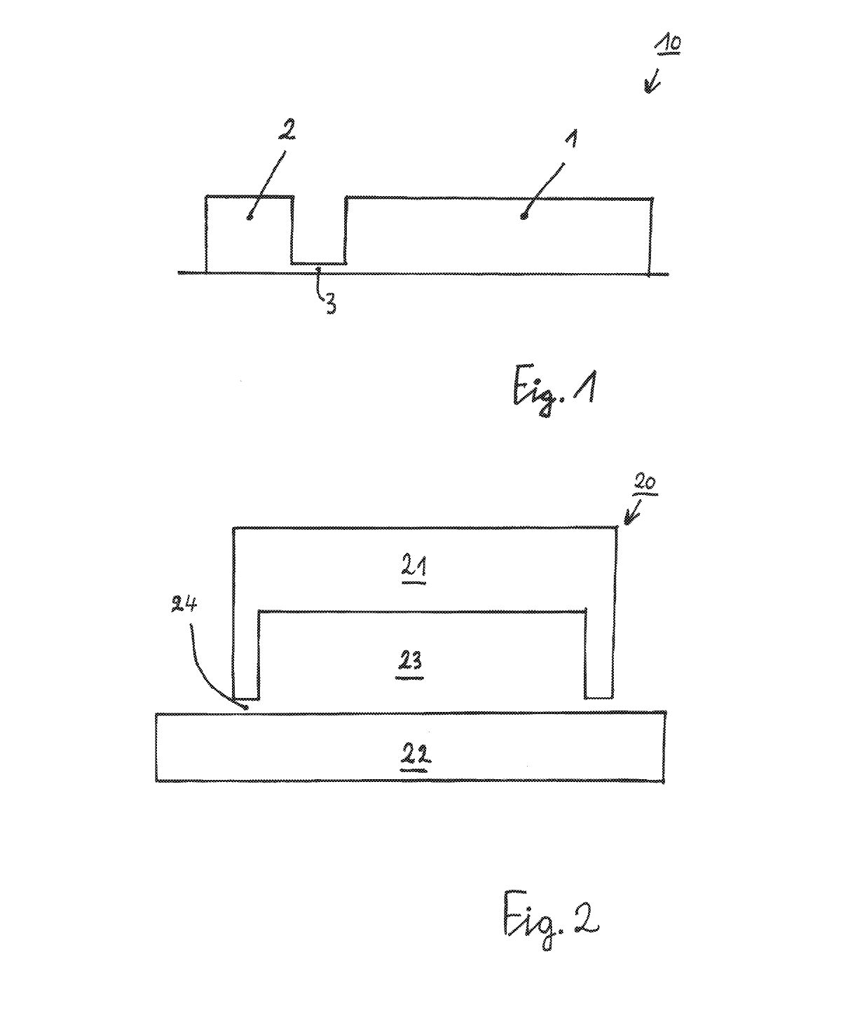

Referring to FIG. 2, there is shown a schematic cross-sectional side view representation of a molding apparatus according to a second aspect. The molding apparatus 20 of FIG. 2 comprises a first tool 21 and a second tool 22, one of which being movable to form a main cavity 23 between them. The molding apparatus 20 further comprises an end position of a movement of one of the first and second tools 21 and 22, in which the end position of the main cavity 23 comprises a minimum spatial volume and the main cavity 23 is connected by a passage 24 to an outer space.

Only one of the first and second tools 21 and 22, in particular the first tool 21, may be configured movable and can be moved upwards and downwards as shown in the embodiment of FIG. 2. In the end position shown in the embodiment of FIG. 2, the first tool 21 can be either in a tool-defined lower-most end position or in a machine-defined end position so that the main cavity 23 may have a pre-defined spatial volume and a certain pre-defined clear height so that any product like, for example, a carrier panel comprising a plurality of semiconductor devices placed on the second tool 22, but also any other molded device or element can be fabricated with a certain pre-defined shape, in particular a certain pre-defined height.

Molding apparatus 20 may further comprise a buffer cavity which is connected to the main cavity 23 by the passage 24. The buffer cavity may comprise a variable spatial volume.

Passage 24 may comprise a vertical dimension in a range less than 1000 μm, or less than 500 μm, or less than 100 μm, in particular 10 μm to 50 μm, more particular 20 μm to 40 μm.

Further examples of the molding apparatus 20 can be formed with any one of the features and embodiments as described above in connection with the molding apparatus 10 of FIG. 1.

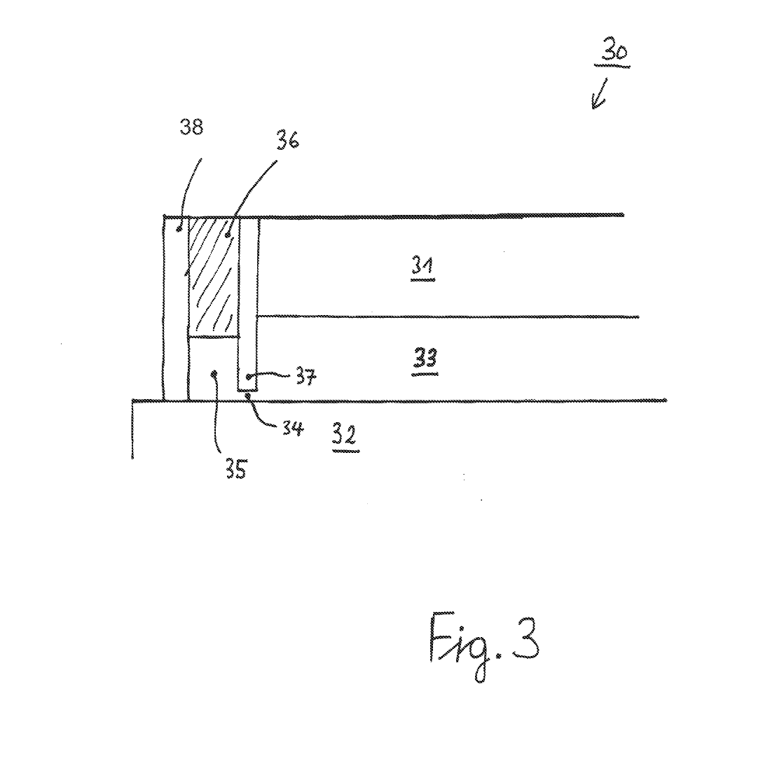

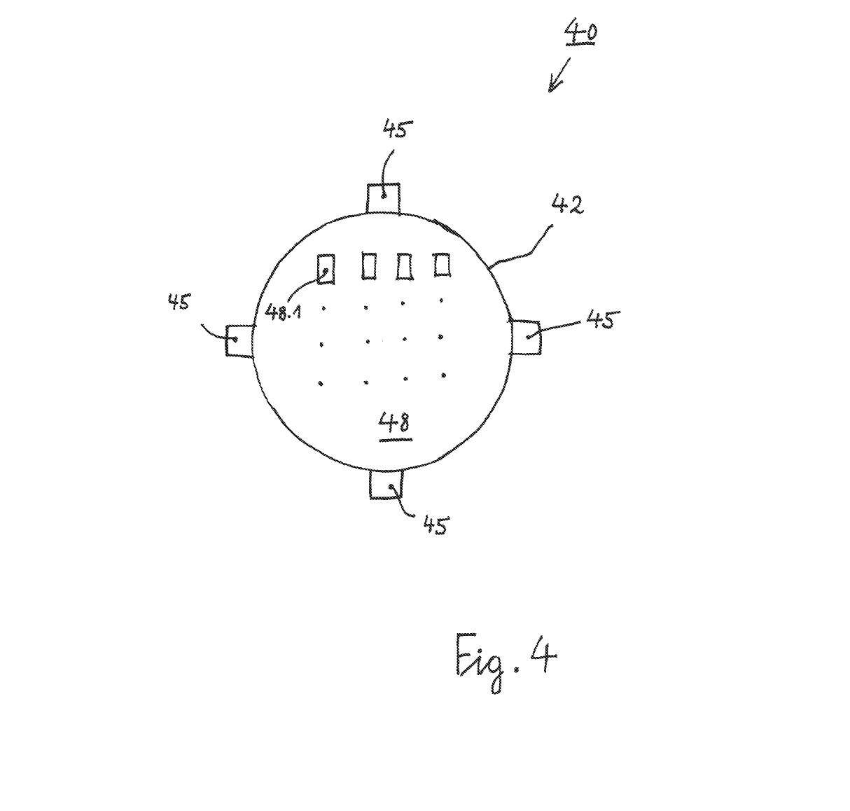

Referring to FIG. 3, there is shown a schematic cross-sectional side view representation of a molding apparatus according to an example. In this representation only a left-sided portion of the molding apparatus 30 is shown. The molding apparatus 30 comprises a first tool 31 and a second tool 32 and a main cavity 33 formed between the first and second tools 31 and 32. The molding apparatus 30 is shown in an end position of a downward movement of the first tool 31 in which the end position of the first tool 31 is either in a tool-defined lower-most end position or in a precisely machine-defined end position and the main cavity 33 has a minimum spatial volume. In an operation of the molding apparatus 30 a carrier panel having a square or circular shape is placed on an upper surface of the second tool 32 and a mold material is dispensed on a central portion of the carrier panel. Alternatively the first tool 31 is then moved downwards until it reaches a pre-defined end position thereby defining a vertical extension of the main cavity 33 and thus also a vertical dimension of the semiconductor chip packages. The end position is defined by a pin 38 which extends through a clamp ring (not shown). The main cavity 33 is connected by a passage 34 with a buffer cavity 35. The spatial volume of the buffer cavity 35 is determined by the position of a plunger 36 which can move upward and downward and which is preloaded by a spring force urging the plunger in a downward direction. The main cavity 33 is separated by the buffer cavity 35 by a boundary wall 37. The vertical extension of the passage 34 between a lower horizontal wall of the boundary wall 37 and an upper horizontal wall of the second tool 32 is, for example, less than 100 μm or 10 μm to 50 μm or 20 μm to 40 μm.

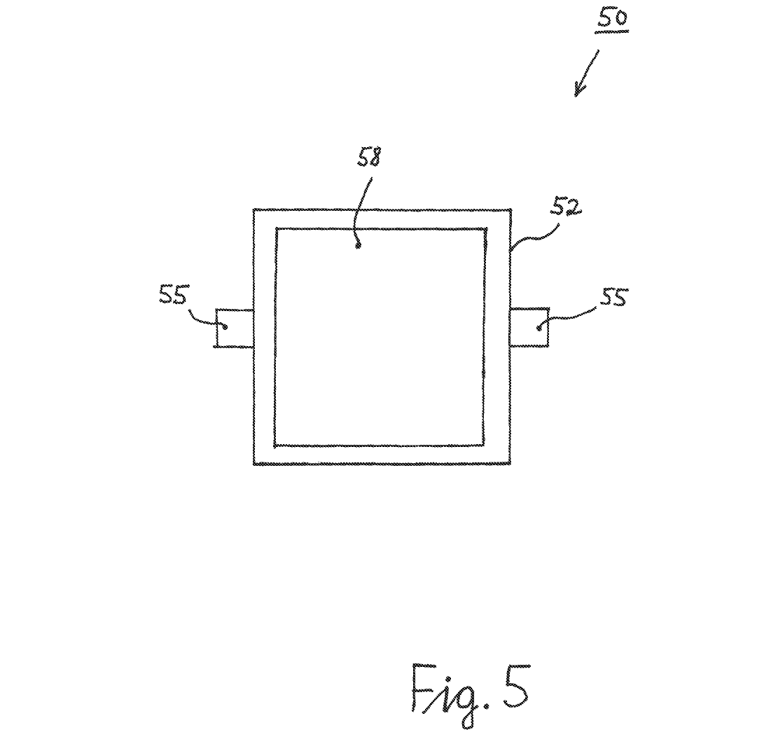

Referring to FIG. 4, there is shown a schematic top view representation of a molding apparatus together with a re-configured wafer according to an example. A second tool 42 of the molding apparatus 40 comprises a circular shape so that any carrier 48 like, for example, a circular shaped re-configured wafer, having a plurality of semiconductor chips 48.1 placed thereupon, can be placed on an upper surface of the second tool 42. The molding apparatus 40 further comprises a plurality of buffer cavities 45 which can be constructed and configured as described in any one of the aspects and embodiments of FIGS. 1-3. The buffer cavities 45 can be arranged lateral to and connected with a main cavity formed between a first tool (not shown) and the second tool 42 of the molding apparatus 40. As shown in FIG. 4, the buffer cavities 45 can be arranged at specific angular positions of the circular shaped molding apparatus 40, in particular at equally spaced angular positions. The buffer cavities 45 are, for example, of identical form and construction.

Referring to FIG. 5, there is shown a schematic top view representation of a molding apparatus according to an example. A second tool 52 of the molding apparatus 50 comprises a square shape so that any square shaped carrier 58 can be placed on an upper surface of the second tool 52. The molding apparatus 50 further comprises two buffer cavities 55 which can be constructed and configured as described in any one of the aspects and embodiments shown and described in connection with FIGS. 1-3. The buffer cavities 55 can be arranged lateral to and connected with a main cavity formed between a first tool (not shown) and the second tool 52 of the molding apparatus 50. As shown in FIG. 5, the buffer cavities 55 can be arranged at opposite side edges of the square shaped molding apparatus 50, in particular they are arranged as shown in FIG. 5, i.e., in a direct opposite relationship with each other where both of the buffer cavities 55 are located in the middle of the two opposing side edges. The buffer cavities 55 are, for example, of identical form and construction.

It should be added that the carrier 48 or 58 used in the embodiments of FIG. 4 or 5 can be any sort of mold form having recesses or grooves in a bottom surface thereof so that products of any form and shape can be fabricated by the molding process.

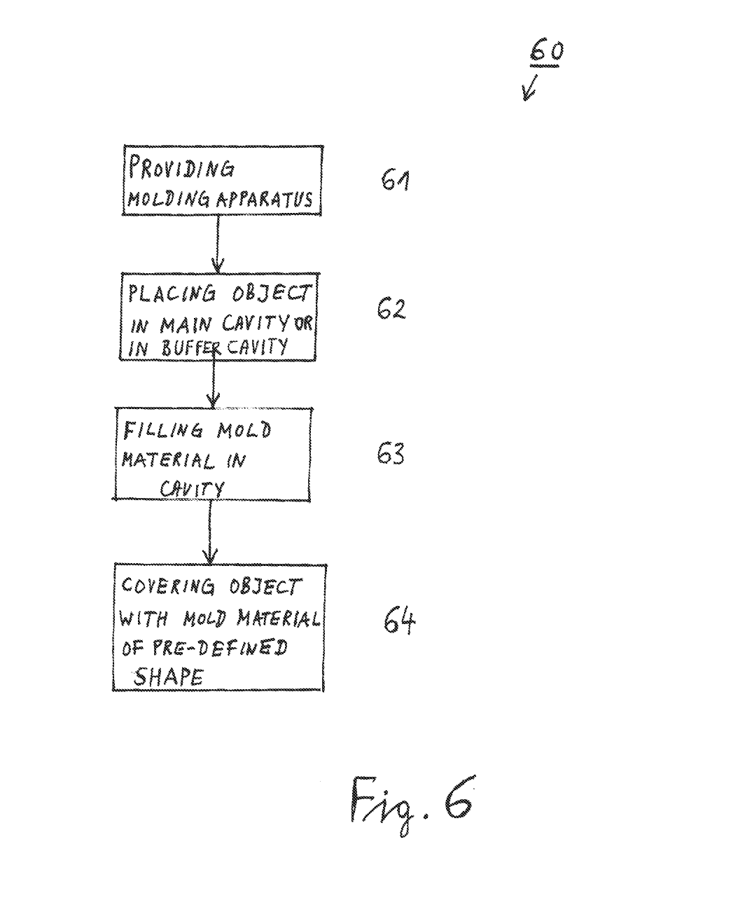

Referring to FIG. 6, there is shown a flow diagram for illustrating a method for molding according to a third aspect. The method 60 comprises providing a molding apparatus comprising a main cavity and a buffer cavity, the buffer cavity connected with the main cavity (61), placing an object in the main cavity and/or in the buffer cavity (62), filling a mold material into the main cavity (63), and encapsulating the object with the mold material until the object is encapsulated with the mold material so that the encapsulated object comprises a pre-defined shape, in particular a pre-defined height (64).

The object can be comprised of a carrier panel, in particular a carrier panel with a plurality of devices like, for example, semiconductor devices, and the carrier panel can be covered with the mold material until the carrier panel and the devices are covered or encapsulated with the mold material up to a pre-defined height. The method can also be applicable to any other products or objects which need a precisely defined shape like, for example, a wing of a car.

The object can be comprised of a mold form comprising one or more recess areas in a surface thereof so that products of any desired form and shape can be fabricated out of the mold material.

Encapsulating the object with the mold material may comprise driving out excess mold material into the buffer cavity. A spatial volume of the buffer cavity can be varied as shown in the aspects and embodiments of FIGS. 1-4.

Covering the object with the mold material may comprise reducing a spatial volume of the main cavity. The molding apparatus may further comprise a first tool and a second tool, one of which is movable to form the main cavity between them, and covering the object with the mold material may comprise moving one of the first and second tools. This was shown, for example, in the embodiments of FIGS. 2 and 3, where the first tool can be moved downward in order to reduce the spatial volume of the main cavity and to distribute the mold material on the entire surface of the carrier like, for example, the re-configured wafer.

The object may be placed in the main cavity but it is also possible that the object is placed in the main cavity is placed in both the main cavity and the buffer cavity or buffer cavities. For example, the object reaches from the main cavity through the passage into the buffer cavity so that in fact one boundary wall of the passage is given by the object extending through the passage. The object can also be placed in the buffer cavity or buffer cavities alone.

While the invention has been illustrated and described with respect to one or more implementations, alterations and/or modifications may be made to the illustrated examples without departing from the spirit and scope of the appended claims. In particular regard to the various functions performed by the above described components or structures (assemblies, devices, circuits, systems, etc.), the terms (including a reference to a “means”) used to describe such components are intended to correspond, unless otherwise indicated, to any component or structure which performs the specified function of the described component (e.g., that is functionally equivalent), even though not structurally equivalent to the disclosed structure which performs the function in the herein illustrated exemplary implementations of the invention.

What is claimed is:

1. A molding apparatus, comprising:
a main cavity; and
a buffer cavity connected with the main cavity.

2. The molding apparatus according to claim 1, further comprising:
a first tool and a second tool, one of which being movable to form the main cavity between them.

3. The molding apparatus according to claim 1, further comprising:
the buffer cavity having a variable spatial volume.

4. The molding apparatus according to claim 1, further comprising:
the buffer cavity having a movable boundary wall.

5. The molding apparatus according to claim 4, further comprising:
the movable boundary wall being preloaded by a force acting on the movable boundary wall so as to reduce a spatial volume of the buffer cavity.

6. The molding apparatus according to claim 1, further comprising:
a plunger forming a boundary wall of the buffer cavity.

7. The molding apparatus according to claim 1, further comprising:
a passage between the main cavity and the buffer cavity.

8. The molding apparatus according to claim 7, further comprising:
the passage being situated between a wall of the main cavity and a wall separating the main cavity from the buffer cavity.

9. The molding apparatus according to claim 7, further comprising:
the passage comprising a width in a range less than about 100 μm in a direction from a wall of the main cavity to a wall separating the main cavity from the buffer cavity.

10. The molding apparatus according to claim 9, further comprising:
the passage comprising a width in a range from about 10 μm to about 50 μm.

11. The molding apparatus according to claim 10, further comprising:
the passage comprising a width in a range from about 20 μm to about 40 μm.

12. The molding apparatus according to claim 1, further comprising:
two or more buffer cavities connected with the main cavity.

13. The molding apparatus according to claim 1, further comprising:
the main cavity being configured to receive a carrier panel, in particular a carrier panel with a plurality of devices to be covered by a mold material.

14. The molding apparatus according to claim 1, further comprising:
the main cavity having a circular shape.

15. The molding apparatus according to claim 14, further comprising:
two or more cavities being arranged at regularly spaced angular positions of the main cavity.

16. A molding apparatus, comprising:
a first tool and a second tool, one of which being movable to form a main cavity between them; and
an end position of a movement of one of the first and second tools, in which an end position of the main cavity comprises a minimum spatial volume and the main cavity is connected by a passage to an outer space.

17. The molding apparatus according to claim 16, further comprising:
a buffer cavity being connected to the main cavity by the passage.

18. The molding apparatus according to claim 17, further comprising:
the buffer cavity having a variable spatial volume.

19. The molding apparatus according to claim 16, further comprising:
the passage comprising a width in a range less than about 100 μm in a direction from a wall of the main cavity to a wall separating the main cavity from the outer space.

20. The molding apparatus according to claim 19, further comprising:
the passage comprising a width in a range from about 10 μm to about 50 μm.

21. The molding apparatus according to claim 20, further comprising:
the passage comprising a width in a range from about 20 μm to about 40 μm.

22. A method for molding, the method comprising:
providing a molding apparatus comprising a main cavity and a buffer cavity connected with the main cavity;
placing an object in the main cavity and/or the buffer cavity;
filling a mold material into the main cavity; and
encapsulating the object with the mold material so that the encapsulated object comprises a pre-defined height.

23. The method for molding according to claim 22, wherein
the object comprises a carrier panel with a plurality of devices, and
the carrier panel is covered with the mold material until the carrier panel is covered with the mold material up to the pre-defined height.

24. The method for molding according to claim 22, wherein
the molding apparatus comprises a buffer cavity connected with the main cavity, the method further comprising:
covering the object with the mold material comprises driving out excess mold material into the buffer cavity.

25. The method for molding according to claim 24, further comprising:
varying a spatial volume of the buffer cavity.

26. The method for molding according to claim 22, further comprising:
covering the object with the mold material comprises reducing a spatial volume of the main cavity.

27. The method for molding according to claim 22, wherein
the molding apparatus further comprises a first tool and a second tool, one of which being movable to form the main cavity between them, the method further comprising:
covering the object with the mold material comprises moving one of the first and second tools.
